(19) United States
(12) Patent Application Publication
(10) Pub. No.: US 2012/0152811 A1
(43) Pub. Date: Jun. 21, 2012

(54) PURIFICATION WATER PACK

(76) Inventor: A. Vernon Wright, Newport Beach, CA (US)

(21) Appl. No.: 13/239,291

(22) Filed: Sep. 21, 2011

Related U.S. Application Data
(60) Provisional application No. 61/425,656, filed on Dec. 21, 2010.

(51) Int. Cl. B01D 29/90; B01D 27/00

(52) U.S. Cl. 210/104

(57) ABSTRACT

A water pack enables water purification in the field. An illustrative water pack can comprise first and second bladders configured to respectively hold treated and untreated water and comprising a filter connector configured to receive and hold a filter between the first and second bladders. A gas bladder connector can be coupled to the first bladder in a configuration to receive and hold a gas bladder internal to the first bladder. A regulator coupled to the gas bladder connector can be configured to attach a pump and regulate pressurization of gas driven by the pump in the gas bladder at a predetermined pressure and volume.

### BACKGROUND

Availability of potable water for consumption is of growing importance worldwide. While many sources of water exist, water quality is often uncertain. If of poor quality, human health may suffer from the consumption. The ability to utilize found water safely will continue to be of concern to both military and non-military persons. Found water for this disclosure is primarily non-salt water sources (lakes, rivers, ponds, ditches, wells, etc.) although additional filtration known as desalination can be performed so that salt water sources could apply to this invention.

Water can be supplied from a variety of sources such as groundwater (aquifers), surface water (lakes and rivers), conservation, and the ocean via desalination. Found water is usually purified by filtration to make potable and available for drinking and other usage. Water supply continuity, while expected in developed countries, is a severe problem in many developing countries. Water may be available only for a few hours every day or a few days a week. Much of the population of developing countries receives water only intermittently.

Hydration products, such as hydration packs, water bottles, canteens, bladders, water packs, liquid reservoirs, and the like are highly useful to facilitate hydration of military and law enforcement agencies around the world, as well as outdoor or recreation uses including hiking, running, bicycling, scuba diving, and the like.

### SUMMARY

Embodiments of a water pack enable water purification in the field. An illustrative water pack can comprise first and second bladders configured to respectively hold treated and untreated water and comprising a filter connector configured to receive and hold a filter between the first and second bladders. A gas bladder connector can be coupled to the first bladder in a configuration to receive and hold a gas bladder internal to the first bladder. A regulator coupled to the gas bladder connector can be configured to attach a pump and regulate pressurization of gas driven by the pump in the gas bladder at a predetermined pressure and volume.

### BRIEF DESCRIPTION OF THE DRAWINGS

Embodiments of the invention relating to both structure and method of operation may best be understood by referring to the following description and accompanying drawings:

FIGS. 1A, 1B, 1C, 1D, and 1E are schematic pictorial diagrams illustrating an embodiment of a water pack that enables water purification;

FIG. 2 is a schematic pictorial diagram showing another embodiment of a purifying water pack;

FIGS. 3A, 3B, and 3C are schematic pictorial diagrams depicting embodiments of canteens adapted for water purification in the field; and

FIGS. 4A and 4B are further embodiments showing water packs with water purification capability.

### DETAILED DESCRIPTION

Embodiments of a water pack or canteen are disclosed with capability to process any found water into potable water that is safe for human consumption.

Some embodiments of the water pack or canteen can have additional adaptation to permit thermal treatment to improve palatability, particularly in hot or cold temperature environments.

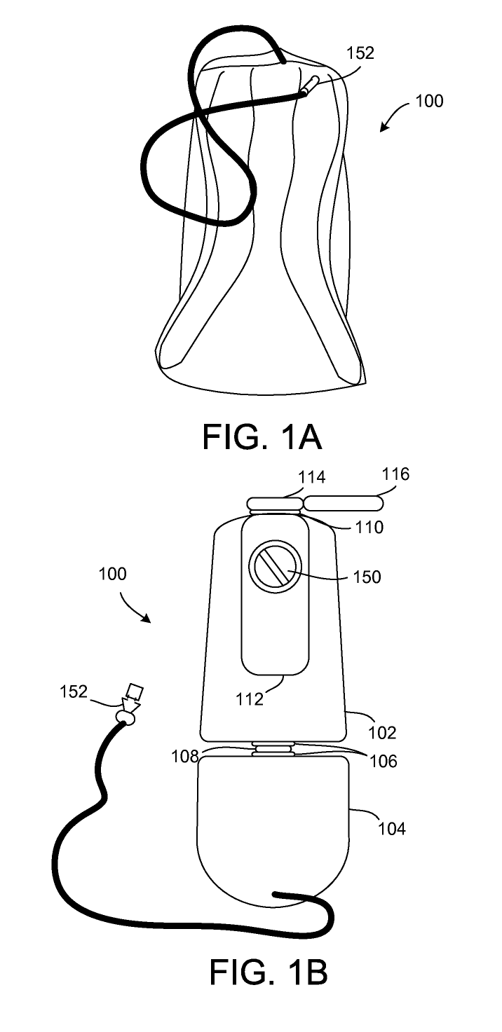

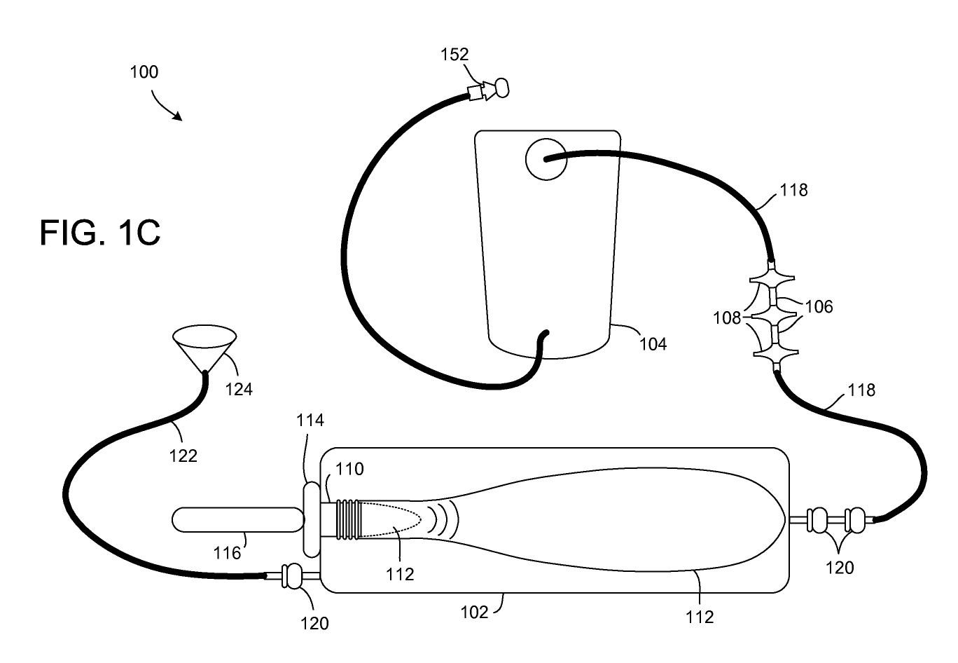

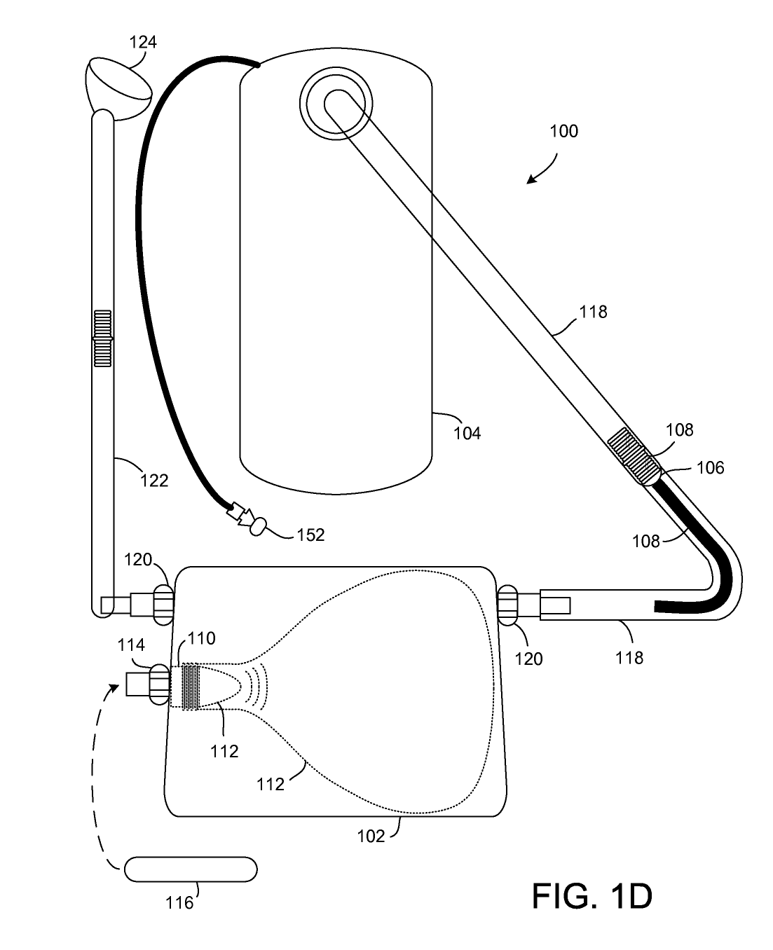

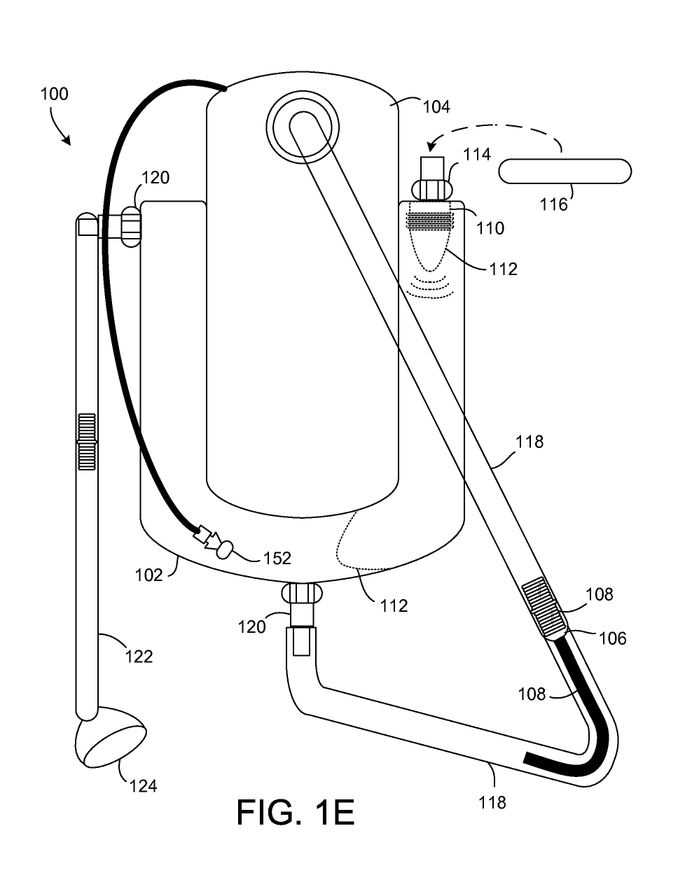

Referring to FIGS. 1A, 1B, 1C, 1D, and 1E, schematic pictorial diagrams illustrate an embodiment of a water pack 100 that enables water purification. FIG. 1A shows the outer backpack of the water pack 100. FIG. 1B depicts the inner components of the water pack 100. An illustrative water pack 100 can comprise first 102 and second 104 bladders, which are depicted in the illustrative example embodiment as body-conformal bladders, configured to respectively hold untreated and treated water. The bladders 102, 104 can comprise a filter connector 106 configured to receive and hold a filter 108 between the first 102 and second 104 bladders. A gas bladder connector 110 can be coupled to the first bladder 102 in a configuration to receive and hold a gas bladder 112 internal to the first bladder 102. A regulator 114 coupled to the gas bladder connector 110 can be configured to attach a pump 116 and regulate pressurization of gas driven by the pump 116 into the gas bladder 112 to a predetermined pressure.

Different implementations can include bladders 102, 104 in various forms including, but not limited to, flexible, composite, ceramic, plastic tubing, metal, Kevlar, carbon fiber, a combination of materials, and the like.

FIGS. 1C and 1D are embodiments of a water pack 100 wherein the first 102 and second 104 bladders are configured respectively as a waist-pack and a backpack. Thus, untreated water is held in the first bladder 102 mounted on the user's waist and treated water held in the second bladder 104 mounted on the user's back. The water pack 100 can include a connecting tube 118 coupled between the first 102 and second 104 bladders. Filter connectors 106 couple to segments of the connecting tube 100, with one or more filters 108 coupled to the filter connectors 106. One or more one-way valves 120 can be coupled to the connecting tube 118 to control fluid flow between the bladders 102 and 104. The water pack 100 can further include a collecting tube 122 coupled to the first bladder 102 for collecting untreated water. A one-way valve 120 can be used to control inflow of water from the collecting tube 122 into the first bladder 102. A funnel 124 can be coupled to the collecting tube 122 to facilitate collection of water.

FIG. 1E is an embodiment of a water pack 100 wherein the first 102 and second 104 bladders are configured respectively as two portions of a backpack. Thus, untreated water is held in the first bladder 102 in a horseshoe configuration mounted on the outer periphery of the backpack and treated water held in the second bladder 104 interior to the first bladder 102 with both the first and second bladders mounted on the user's back.

The pump 116 can be any suitable type of pumping device. For example, a gas supply canister can be used as a simple pumping device. Other suitable types of pumps can include positive displacement pumps such as gear pumps, progressive cavity pumps, roots-type pumps, peristaltic pumps, and reciprocating-type pumps. Further suitable types of pumps can be selected such as buoyancy pumps including gas supply canisters and compressed-air powered double-diaphragm pumps, and impulse pumps including hydraulic ram pumps. Still other suitable pumps can include gravity pumps, steam pumps, and velocity pumps such as centrifugal pumps, radial flow pumps, axial flow pumps, mixed flow pumps, educator-jet pumps, and the like.

The water pack 100 can be implemented with several disposable components to facilitate replacement of consumed and/or dirty items. For example, the filter 108 can be disposable. The filter 108 can be configured for attachment to the filter connector 106 and operation in removing solids and pathogens from the untreated water in the first bladder 102, thereby producing potable water in the second bladder 104. The filter 108 can be selected from various types including ultrafiltration, microfiltration, nanofiltration filters. Other suitable filters can have functionality including desalination, heavy metal filtration, solids filtration, activated carbon filtration, and filtering of various solids, pathogens, and the like.

The gas bladder 112 can also be implemented as a disposable component. The gas bladder 112 can be configured for attachment to the gas bladder connector 110 internal to the first bladder 102 for pressurization of gas that forces the untreated water in the first bladder 102 through the filter 108 to the second bladder 104 to produce potable water.

In some embodiments, the pump 116 can also be implemented as a disposable component. For example, the pump 116 can be configured for attachment to the regulator 114 for driving the gas into the gas bladder 112, forcing water from the first bladder 102 through the filter 108 to the second bladder 104 to purify a predetermined volume of water.

Untreated water can be entered into the first bladder 102 via an end-cap 150. Treated water can be taken from the second bladder 104 via a mouth squeeze valve 152.

In some embodiments, the bladders 102, 104 can be body-conformal to facilitate carrying convenience and comfort.

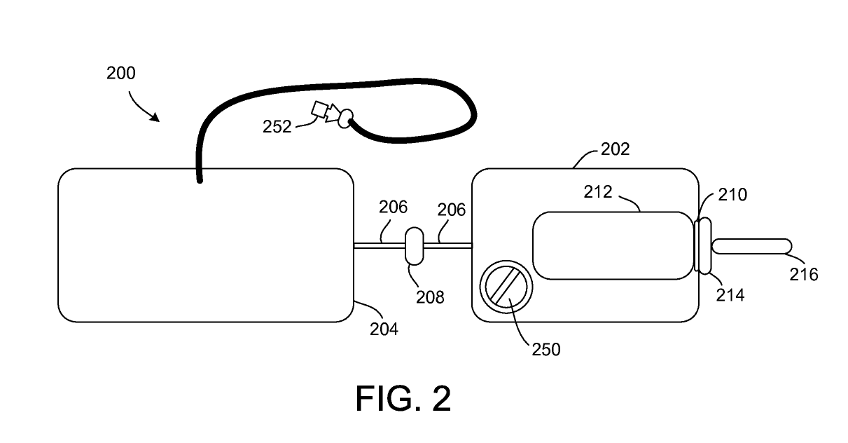

Referring to FIG. 2, a schematic pictorial diagram illustrates another embodiment of a purifying water pack 200. An illustrative purifying water pack 200 can comprise first 202 and second 204 water bladders configured to respectively hold untreated and treated water. The water pack 200 can have one or more connectors or mounts for holding disposable components. For example, a filter connector 206 can be coupled to the water bladders 202, 204 in a configuration to receive and hold a filter 208. A gas bladder connector 210 can be coupled to the water bladder 202 in an arrangement that enables the gas bladder connector 210 to receive and hold a gas bladder 212 internal to the first water bladder 202. A regulator 214 can be coupled to the gas bladder connector 210 and can include a connector configured to attach a gas cartridge 216 and regulate pressurization of gas driven by the gas cartridge 216 in the gas bladder 212 to a predetermined pressure.

The purifying water pack 200 can further comprise one or more disposable components that can be attached or inserted into appropriate connectors of the water pack 200. For example, one or more disposable filters 208 configured for attachment to the various filter's connectors 206 can be used to remove a selected combination of contaminants solids including heavy metals such as arsenic, lead, mercury, and the like, and pathogens such as bacteria, viruses, cysts, medical waste from the untreated water in the first water bladder 202. Desalination filters can also be selected. A particular filter 208 can be selected to address pathogens and metals known to be in a specific water source. The disposable filter 208 can be an ultrafiltration, microfiltration, nanofiltration, desalination filter or the like. The gas bladder 212 can also be disposable and can be configured for attachment to the gas bladder connector 210 internal to the first water bladder 202. Untreated water can be entered into the first water bladder 202 via an end-cap 250. The gas bladder 212 holds pressurized gases from the gas cartridge 216 to force untreated water contained in the first water bladder 202 through the filter 208 to the second water bladder 204. The gas cartridge 216 can also be a disposable item. The disposable gas cartridge 216 configured for attachment to the regulator 214 for driving the gas into the gas bladder, forcing water from the first water bladder through the filter to the second water bladder wherein a predetermined volume of liquid is purified. Treated water can be taken from the second water bladder 204 using a mouth squeeze valve 252.

In an example configuration, the disposable filter 208 can be arranged as multiple filters to enable desired functionality. For example, a filter local to the bladders 202 and 204 can be used to filter most solids and pathogens and can be supplemented by a distal filter such as a desalination filter. Accordingly, a configuration for filtering “found water” that does not include salt water can be supplemented with a distal desalination filter to enable filtering of all water types.

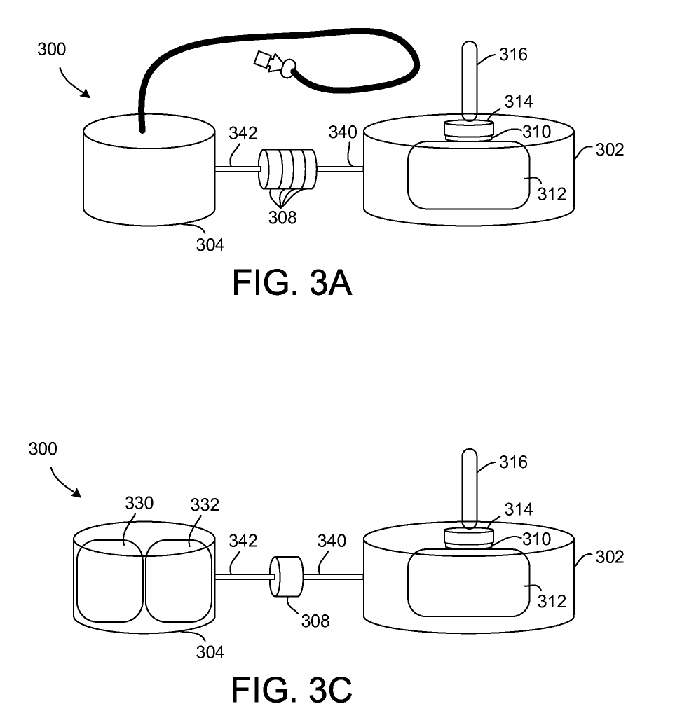

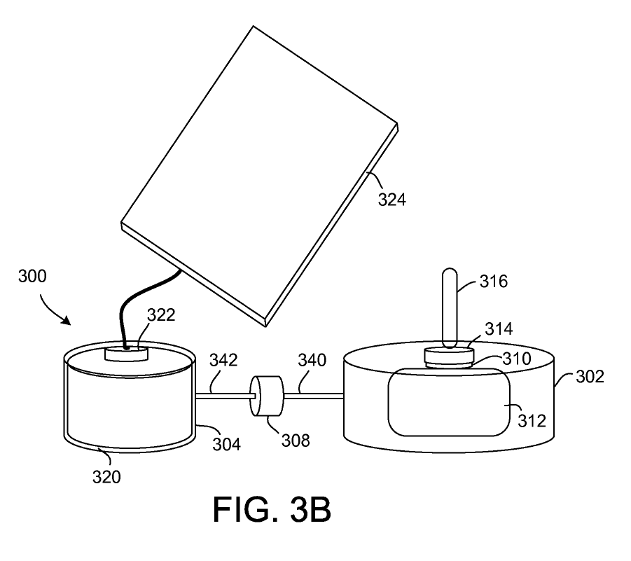

Referring to FIGS. 3A, 3B, and 3C, schematic pictorial diagrams show embodiments of canteens 300 adapted for water purification in the field. As shown in FIG. 3A, an illustrative purification canteen 300 can comprise first 302 and second 304 liquid receptacles configured to respectively hold treated and untreated liquid and a filter 308 coupled between the first 302 and second 304 liquid receptacles. The purification canteen 300 can further comprise a gas bladder 312 internal to the first liquid receptacle 302 and a regulator 314 coupled to the gas bladder 312 which is configured to regulate pressurization of gas in the gas bladder 312 to a predetermined pressure and to purify a predetermined volume of liquid. A pump 316 can be coupled to the regulator 314 configured to drive the gas into the gas bladder 312, thereby forcing liquid from the first liquid receptacle 302 through the filter 308 to the second liquid receptacle 304.

The purification canteen 300 can be adapted to use a single filter 308 (FIGS. 3B and 3C) or multiple filters 308 (FIG. 3A). In an implementation that supports multiple filters 308, the filters and filter connectors can be configured to enable selection of the particular filters and the number of filters in an arrangement.

In an example embodiment, the filter 308 can be selected from various types including ultrafiltration, microfiltration, nanofiltration filters. Other suitable filters can have functionality including desalination, heavy metal filtration, solid filtration, activated carbon filtration, and filtering of solids, pathogens, and the like.

In various implementations, the pump 316 can be a gas supply cartridge. In some configurations, the pump 316 can be pumps driven by gravity force, manual operation such as hand pumping, engine-driven such as driven by fossil fuel engines such as a diesel engine or other suitable engines, other mechanical systems, solar power systems, and the like. Other pumps can be driven by wind, breath, and similar energy sources.

In some configurations, the pump 316 and the regulator 314 can be formed as a combined, integrated (integral) component. In other arrangements, the pump 316 and the regulator 314 are configured as separate components.

Several components of the canteen 300 can be implemented as disposables. For example, one or more of the pump 316, the filter 308, and the gas bladder 312 can be disposable items, enabling replacement of dirty and/or consumed articles. For example, the pump 316 and the filter 308 can be disposable for disposal after a selected number of liquid batch processing instances.

The regulator 314 can be controllable to perform pressurization at a selected time, pressure, and volume to produce a predetermined quantity of potable liquid.

The canteen or liquid reservoir 300 can be implemented so that the liquid volume contained in the first liquid receptacle 302 is less than the liquid volume contained in the second liquid receptacle 304. Receptacle sizes can be selected so that newly processed potable water in the second liquid receptacle 304 has a larger volume than the untreated carried volume in the first liquid receptacle 302. For example, the one liter of treated water can be purified for a canteen with capacity of three liters. In some configurations, multiple volumes may be treated as requirements for the amount of treated water change.

An example embodiment of the purifying canteen 300 can comprise a first transfer tube 340 coupled between the first liquid receptacle 302 and the filter 308 that can contain pressurized liquid impinging on the filter 308, thereby forcing the liquid through the filter 308, purifying the liquid to potable standards. A second transfer tube 342 coupled between the filter 308 and the second liquid receptacle 304 moves the filtered liquid to the second liquid receptacle 304.

In some implementations, the second liquid receptacle 304 can be formed in a collapsible arrangement that prevents interior gas bubbles and associated sloshing noise.

In the illustrative canteen embodiment, the first 302 and second 304 liquid receptacles can be configured as flexible bladders conformal to contours of a user's body. Other implementations can take other forms.

Some implementations of the purifying canteen 300 can support thermal treatment to supply cold and/or hot water. For example, as shown in FIG. 3B, the second liquid receptacle 302 can be configured with thermal insulation 320 and/or a thermal treatment element 322.

In another arrangement, a thermal treatment component 322 can be coupled to the second liquid receptacle 304 which is adapted to thermally treat liquid in the second liquid receptacle 304. Various energy sources can be used to power thermal treatment. For example, a solar panel 324 can be coupled to the thermal treatment component 322 to supply energy to the thermal treatment component 322. Examples of thermal treatment components can include cooling coils configured for cooling water (for example using flow of cooling air across the coils) and heating coils configured for heating the water.

In another example configuration, a thermal treatment component 322 can be an aqueous composition for thermal dispensing containing a compound capable of exothermic oxidation-reduction reaction, possibly including a catalyst to accelerate the reaction. Accordingly, heating and/or cooling can be generated by oxidization wherein the compound comes into contact with air/oxygen. One example compound for exothermic oxidation-reduction reaction with hydrogen peroxide may be selected from ascorbic acid, ascorbic acid salts and esters, and a metal salt catalyst for reaction acceleration. In an example arrangement, a two compartment container can be used such that the composition can be pressurized in one compartment and hydrogen peroxide contained in the second compartment. A co-dispensing valve can separate the compartments and, upon actuation, mixes the liquids from the two compartments, reacting and releasing the heat of reaction to supply heat.

FIG. 3C shows another embodiment of a purifying canteen 300 that supports thermal treatment to produce both hot and cold water. For example, the second liquid receptacle 304 comprises a first insulated pouch 330 configured to hold hot liquid and a second insulated pouch 332 configured to hold cold liquid.

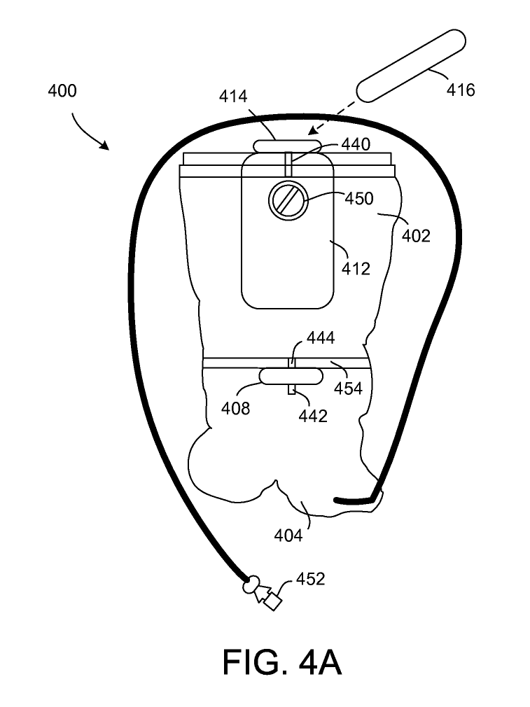

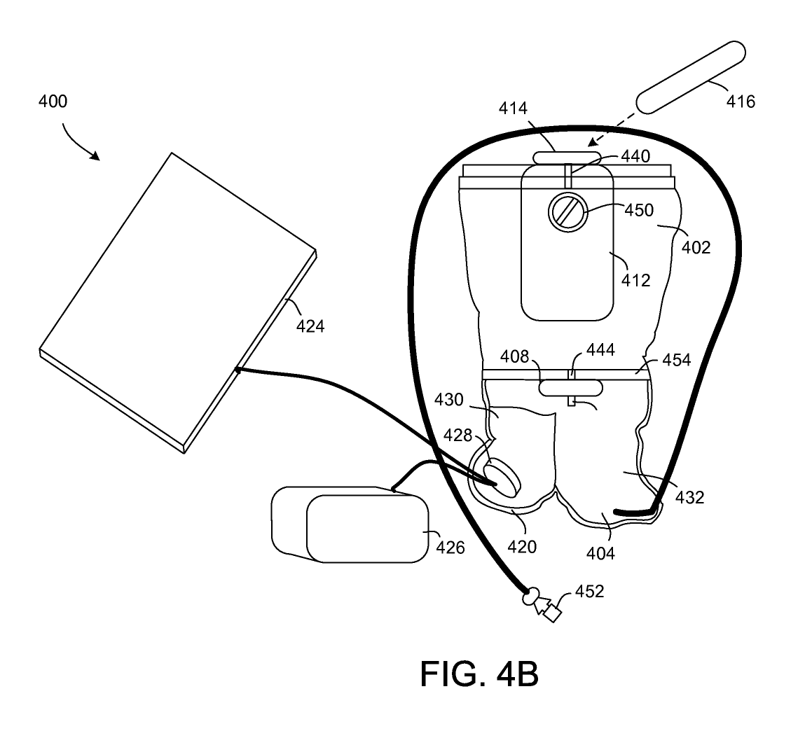

Referring to FIGS. 4A and 4B, further embodiments of water packs 400 with water purification capability are shown. The illustrative water pack 400 shown in FIG. 4A enables purification of any earth-found water to potable water standards. The illustrative water pack 400 comprises an external pressure chamber enclosure 402, for example in the form of a plastic bladder, tube or tubing, and a gas bladder 412 that is positioned internal to the external pressure chamber enclosure 402. An end cap 450 coupled to one end of the external pressure chamber enclosure 402 can function as a pressure vessel and fill port. A bladder plate 454 can be coupled at the end of the external pressure chamber enclosure 402 opposite to the end cap 450. The bladder plate 454 separates the liquid fluid from a gas bladder 412 and untreated water in the external pressure chamber enclosure 402. The depicted embodiment further comprises a gas supply cartridge 416 that supplies energy to pressurize the batch water to be purified, and a pressure regulator 414 and flow passages. One flow passage 440 enables regulated gas to fill and expand the inner gas bladder 412. A second passage 444 enables found water, when pressurized by the gas bladder 412, to flow below the bladder plate 454 where the water is filtered to potable water standards. A filter 408, for example a membrane or other type of filter, removes solids and pathogens to produce potable water. A transfer tube 442 enables potable water exiting the filter 408 to pass into a storage vessel 404 which stores the potable water. The potable water transferred to the storage vessel 404 may be consumed, for example using squeezable access via a mouth tube that is often used for water packs such as a Camelbak™ water backpack. Treated water can be taken from the storage vessel 404 via a mouth squeeze valve 452.

The configuration of a water pack 400 with water purification driven by a gas cartridge 416 facilitates usage of an ultrafiltration filter 408 with substantially smaller pore size while having a suitable purification time, enabling improved filtration of tiny impurities. Usage of the gas cartridge 416 thus has some advantages over other pressurization systems that rely on gravity, hand pump, or other structures and techniques. In some embodiments, the water pack 400 can be configured for usage of the other pressurization systems or can be configured with attachments that enable selection from different pressurization systems.

The regulator 414 enables the purification water pack 400 to operate efficiently without ongoing attention since the gas supply cartridge 416 processed by the regulator 414 performs pressurization at a suitable time and volume to produce a batch of potable water. Inclusion of the regulator 414 improves user access to water. For example for military usage, soldier survivability is improved since the soldier is not distracted by need to “pump” or visually monitor the process. In recreational usage, the regulator 414 enables automatic pumping and control in steep or hazardous terrain, and while running, cycling, skiing, and the like.

The pressure regulator 414 can be configured to enable a metered flow of pressurized gas which is optimized to the performance of the filter 408.

The pressure regulator 414 can have a highly simplified implementation, for example comprising a housing, piston, o-ring, and spring wherein the o-ring replaces a diaphragm that is commonly used. The simplified pressure regulator has a higher mean time before failure (MTBF) and avoids a pressure adjustment screw and seal that create addition risk of failure.

Several components of the purification water pack 400 can be disposable. Disposables can be implemented to enable processing of one or multiple water batches. Various components most suitable for implementation as disposable can include the gas cartridge 416, the filter 408, the gas bladder 412, and possibly other items. For example, a membrane filter 408 can be disposable, allowing extended use of the water pack 400. Various types and models of filters 408 can be convertibly coupled to the water pack 400, depending on the impurities desired to be removed. Some filters can be selected with pore sizes adapted for certain minerals and substances such as arsenic, aluminum, fluoride, and the like. Some filters can have desalination capability. The design may also be adapted to enable hydration water to scuba (Self Contained Underwater Breathing Apparatus), snorkelers, free divers, and other underwater activity to convert sea water or water at different salinity levels from fresh water to brackish water, saline water, and brine, to potable drinking water. For example, a scuba diver commonly breathes a mixture of compressed oxygen or Nitrox breathing air gas, which dries the mount. The water pack can be configured to desalinate sea water to potable drinking water, thereby improving safety and comfort of underwater activity.

An embodiment of a water pack 400 is particularly directed to produce potable water from any found earth source, collapsible components and to include noise and thermal treatment of stored/carried water volume. The water pack 400 can enable a water volume to be purified by batch. The water pack 400 comprises a gas cartridge 416 supplying stored energy for water purification and a pressure regulator 414 for administering gas at proper pressure and volume per batch. The gas cartridge 416, the pressure regulator 414, and other components can be part of an integral system or separated components.

The water pack 400 can further comprise an outer pressure vessel 402 containing water volume to be purified, a fill port and an inner collapsible pressure vessel 412. The outer vessel 402 can be solid or collapsible to prevent sloshing and noise associated with sloshing. The collapsible inner pressure vessel 412 receives metered gas causing the vessel 412 to expand with such expansion expelling an equivalent volume of batch water under pressure.

The pressure bladder may remain inflated to reduce water sloshing or the pressure may be expelled with no remaining liquid. The water pack may further include a valve (not shown) in an arrangement that muffles the sound of pressurized air released from the found (untreated) water vessel.

A first transfer tube 444 contains expelled pressurized water. A filter 408 receives pressurized water and purifies the water to potable water standards. The filtered water moves through a second transfer tube 442 into a final storage vessel 404.

The storage vessel 404 can be collapsible to prevent sloshing and noise associated with sloshing.

In some arrangements, a water pack 400 can be supplemented with features to treat thermal quality of the water consumed. Referring to FIG. 4B, some embodiments of the water pack 400 can have a thermal processing functionality. Purified water can be stored in a vessel 404 that may be insulated and adapted for thermal treatment. In an example implementation, the vessel 404 can be insulated using a nano-insulation material 420, possibly the best R-value material available.

Thermal treatment can be an optional aspect of water pack 400 functionality and can enable cooling, heating, or both heating and cooling. Stored water may be thermally treated, for example using solar energy 424 directly or by combining solar heating with battery storage 426.

In an example system, a solar panel or panels 424 may be placed on the water pack or elsewhere near the storage vessel 404. The solar panel 424 may feed electrical energy to a battery 426 or directly to a Thermal Electric Component (TEC) 428. TEC 428 may take several forms. The TEC 428 may be a heater for cold climates or a cooler for warm climates. Examples of TEC devices 428 (TEC) can include heat coils, Peltier devices, heat pipes, or others. TEC 428 in the form of a Peltier device can either heat or cool by switching polarity of electrical energy to TEC. For example, 113 or more BTU/hour is attainable from a single Peltier device.

The storage vessel 404 can include insulation 420 to reduce heat exchange with ambient air. The storage vessel 404 may contain heating or cooling mechanism 428 to supply stored water at a more palatable temperature. For example, a Thermal Electric Component (TEC) 428 may be a heater for cold climate or a cooler for warm climate. For example, a TEC 428 in the form of a Peltier device can either heat or cool by switching polarity of electrical energy to TEC. The waste thermal effect—the opposite of the heating or cooling generated by the Peltier device—can be exhausted to atmosphere or driven into an auxiliary insulated pouch to produce opposite temperature water, giving potential to have two insulated pouches, one hot 430 and one cold 432.

Terms “substantially”, “essentially”, or “approximately”, that may be used herein, relate to an industry-accepted variability to the corresponding term. Such an industry-accepted variability ranges from less than one percent to twenty percent and corresponds to, but is not limited to, materials, shapes, sizes, functionality, values, process variations, and the like. The term “coupled”, as may be used herein, includes direct coupling and indirect coupling via another component or element where, for indirect coupling, the intervening component or element does not modify the operation. Inferred coupling, for example where one element is coupled to another element by inference, includes direct and indirect coupling between two elements in the same manner as “coupled”.

The illustrative pictorial diagrams depict structures and process actions in a manufacturing process. Although the particular examples illustrate specific structures and process acts, many alternative implementations are possible and commonly made by simple design choice. Manufacturing actions may be executed in different order from the specific description herein, based on considerations of function, purpose, conformance to standard, legacy structure, and the like.

While the present disclosure describes various embodiments, these embodiments are to be understood as illustrative and do not limit the claim scope. Many variations, modifications, additions and improvements of the described embodiments are possible. For example, those having ordinary skill in the art will readily implement the steps necessary to provide the structures and methods disclosed herein, and will understand that the process parameters, materials, shapes, and dimensions are given by way of example only. The parameters, materials, and dimensions can be varied to achieve the desired structure as well as modifications, which are within the scope of the claims. Variations and modifications of the embodiments disclosed herein may also be made while remaining within the scope of the following claims.

What is claimed is:

1. A liquid reservoir comprising:
first and second liquid receptacles configured to respectively hold treated and untreated liquid;
a filter coupled between the first and second liquid receptacles;
a gas bladder internal to the first liquid receptacle;
a regulator coupled to the gas bladder configured to regulate pressurization of gas in the gas bladder to a predetermined pressure and to purify a predetermined volume of liquid; and
a pump coupled to the regulator configured to drive the gas into the gas bladder, forcing liquid from the first liquid receptacle through the filter to the second liquid receptacle.

2. The liquid reservoir according to claim 1 wherein:
the pump is a gas supply cartridge.

3. The liquid reservoir according to claim 1 wherein:
the pump is selected from a group consisting of gravity force, manual pump, engine-driven, diesel engine-driven, solar-powered, wind-driven, air-driven, and breath-driven.

4. The liquid reservoir according to claim 1 wherein:
the pump and the regulator are configured in an integral component.

5. The liquid reservoir according to claim 1 wherein:
the pump and the regulator are configured as separate components.

6. The liquid reservoir according to claim 1 wherein:
liquid volume contained in the first liquid receptacle is less than the liquid volume contained in the second liquid receptacle.

7. The liquid reservoir according to claim 1 wherein:
the regulator is controllable to perform pressurization at a selected time and volume to produce a predetermined quantity of potable liquid.

8. The liquid reservoir according to claim 1 wherein:
the pump and the filter are configured for disposal and replacement after a selected number of liquid batch processing instances.

9. The liquid reservoir according to claim 1 wherein:
the second liquid receptacle comprises thermal insulation and/or a thermal treatment element.

10. The liquid reservoir according to claim 1 further comprising:
a thermal treatment component coupled to the second liquid receptacle configured to thermally treat liquid in the second liquid receptacle.

11. The liquid reservoir according to claim 1 further comprising:
a thermal treatment component coupled to the second liquid receptacle configured to thermally treat liquid in the second liquid receptacle; and
a solar panel coupled to the thermal treatment component configured to supply energy to the thermal treatment component.

12. The liquid reservoir according to claim 11 wherein:
the second liquid receptacle comprises a first insulated pouch configured to hold hot liquid and a second insulated pouch configured to hold cold liquid.

13. The liquid reservoir according to claim 1 wherein:
the second liquid receptacle is configured in a collapsible arrangement that prevents interior gas bubbles and associated sloshing noise.

14. The liquid reservoir according to claim 1 further comprising:
a first transfer tube coupled between the first liquid receptacle and the filter configured to contain pressurized liquid impinging on the filter, forcing the liquid through the filter and purifying the liquid to potable standards; and
a second transfer tube coupled between the filter and the second liquid receptacle configured to move the filtered liquid to the second liquid receptacle.

15. The liquid reservoir according to claim 1 wherein:
the first and second liquid receptacles are configured as flexible bladders conformal to contours of a user's body.

16. A purifying water pack comprising:
first and second bladders configured to respectively hold treated and untreated water and comprising a filter connector configured to receive and hold a filter between the first and second bladders;
a gas bladder connector coupled to the first bladder configured to receive and hold a gas bladder internal to the first bladder; and
a regulator coupled to the gas bladder connector configured to attach a pump and regulate pressurization of gas driven by the pump in the gas bladder to a predetermined pressure.

17. The water pack according to claim 16 further comprising:
a filter configured for attachment to the filter connector and operable to remove solids and pathogens from the untreated water in the first bladder wherein potable water is produced in the second bladder.

18. The water pack according to claim 16 further comprising:
a gas bladder configured for attachment to the gas bladder connector internal to the first bladder and configured for pressurization of gas that forces the untreated water in the first bladder through the filter to the second bladder as potable water.

19. The water pack according to claim 16 further comprising:
a pump configured for attachment to the regulator for driving the gas into the gas bladder, forcing water from the first bladder through the filter to the second bladder wherein a predetermined volume of water is purified.

20. A purifying water pack comprising:
first and second water bladders configured to respectively hold treated and untreated water;
a filter connector coupled to the water bladders configured to receive and hold a filter;
a gas bladder connector coupled to the water bladders configured to receive and hold a gas bladder internal to the first water bladder;
a regulator coupled to the gas bladder connector configured to attach a gas cartridge and regulate pressurization of gas driven by the gas cartridge in the gas bladder to a predetermined pressure;
at least one disposable filter configured for attachment to the filter connector and configured to remove a selected combination of contaminants including solids, pathogens, heavy metals, and salt from the untreated water in the first water bladder;
a disposable gas bladder configured for attachment to the gas bladder connector internal to the first water bladder and configured for pressurization of gas that forces the untreated water in the first water bladder through the filter to the second water bladder; and
a disposable gas cartridge configured for attachment to the regulator for driving the gas into the gas bladder, forcing water from the first water bladder through the filter to the second water bladder wherein a predetermined volume of liquid is purified.
